(19) United States
(12) Patent Application Publication
(10) Pub. No.: US 2004/0158834 A1
(43) Pub. Date: Aug. 12, 2004

(54) Apparatus and method for dynamically allocating resources of a dead logical partition

(75) Inventors: Nicholas Stephen Ham, Indianapolis, IN (US); Micah William Miller, Bloomington, MN (US)

Correspondence Address: IBM CORPORATION, ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY

(21) Appl. No.: 10/360,251

(22) Filed: Feb. 6, 2003

(51) Int. Cl. G06F 9/00

(52) U.S. Cl. 718/104

(57) ABSTRACT

A dynamic resource allocation apparatus and method detects when a logical partition is dead, and attempts to allocate any of the dead logical partition's shared resources to a live logical partition after shutting down the dead logical partition. This allows the shared resources of the dead logical partition to be used, where possible, by shifting the resources to one or more logical partitions that are still alive. In this manner the shared resources are used to the fullest extent possible, without wasting shared resources simply because they are owned by a dead logical partition.

### BACKGROUND OF THE INVENTION

1. Technical Field

This invention generally relates to data processing, and more specifically relates to allocation of shared resources in a computer system.

2. Background Art

Since the dawn of the computer age, computer systems have evolved into extremely sophisticated devices that may be found in many different settings. Computer systems typically include a combination of hardware (e.g., semiconductors, circuit boards, etc.) and software (e.g., computer programs). As advances in semiconductor processing and computer architecture push the performance of the computer hardware higher, more sophisticated computer software has evolved to take advantage of the higher performance of the hardware, resulting in computer systems today that are much more powerful than just a few years ago.

The combination of hardware and software on a particular computer system defines a computing environment. Different hardware platforms and different operating systems thus provide different computing environments. In recent years, engineers have recognized that it is possible to provide different computing environments on the same physical computer system by logically partitioning the computer system resources to different computing environments. The iSeries computer system developed by IBM is an example of a computer system that supports logical partitioning. If logical partitioning on an iSeries computer system is desired, partition manager code (referred to as a “hypervisor” in iSeries terminology) is installed that allows defining different computing environments on the same platform. Once the partition manager is installed, logical partitions may be created that define different computing environments. The partition manager manages the logical partitions to assure that they can share needed resources in the computer system while maintaining the separate computing environments defined by the logical partitions.

A computer system that includes multiple logical partitions typically shares resources between the logical partitions. For example, a computer system with two logical partitions could be defined that allocates 50% of the CPU to each partition, and that allocates 33% of the memory to the first partition and 67% of the memory to the second partition. Once logical partitions are defined and shared resources are allocated to the logical partitions, each logical partition acts as a separate computer system. Thus, in the example above that has a single computer system with two logical partitions, the two logical partitions will appear for all practical purposes to be two separate and distinct computer systems.

Logical partitions are one specific example of a shared resource environment, because resources on a computer system may be shared between partitions. One problem with known shared resource environments occurs when a logical partition stops working properly. If a logical partition begins to act abnormally, the logical partition has the potential of corrupting shared resources. In order to protect shared resources from corruption, the dead or stalled logical partition must be shut down completely by a running logical partition. In many shared resource environments, two logical partitions are paired together, and each monitors the other to assure the other logical partition is still functioning properly. If a first logical partition detects that a second logical partition quits working properly, the first logical partition executes a function that shuts down the second logical partition completely. The problem with this approach is that all resources that were owned by the malfunctioning logical partition are now gone. Without a way to dynamically allocate shared resources of a dead logical partition to a live logical partition, the computer industry will continue to suffer from resources that are wasted when a logical partition that owns the resources dies in a shared resource environment.

### DISCLOSURE OF INVENTION

A dynamic resource allocation apparatus and method detects when a logical partition is dead, and attempts to allocate any of the dead logical partition's shared resources to a live logical partition after shutting down the dead logical partition. This allows the shared resources of the dead logical partition to be used, where possible, by shifting the resources to one or more logical partitions that are still alive. In this manner the shared resources are used to the fullest extent possible, without wasting shared resources simply because they are owned by a dead logical partition.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a computer apparatus that supports logical partitioning and dynamic resource allocation in accordance with the preferred embodiments;

FIG. 2 is a block diagram showing allocation of total processing between two logical partitions;

FIG. 3 is a block diagram showing allocation of total memory between two logical partitions;

FIG. 4 is a flow diagram illustrating a prior art method for handling a dead logical partition;

FIG. 5 is a block diagram showing how the 50% processing power owned by a dead logical partition is wasted when the dead logical partition is shut down;

FIG. 6 is a block diagram showing how the 67% memory owned by a dead logical partition is wasted when the dead logical partition is shut down;

FIG. 7 is a flow diagram of a method in accordance with the preferred embodiments for handling a dead logical partition;

FIG. 8 is a block diagram showing how the 50% processing power owned by partition 2 in FIG. 2 is reallocated to partition 1 after partition 2 is shut down; and

FIG. 9 is a block diagram showing how the 67% memory owned by partition 2 in FIG. 3 is reallocated to partition 1 after partition 2 is shut down.

### BEST MODE FOR CARRYING OUT THE INVENTION

According to preferred embodiments of the present invention, when a logical partition dies, a dynamic resource allocation mechanism attempts to allocate all resources owned by the dead logical partition to a live logical partition after shutting down the dead logical partition. In this manner, the resources owned by the dead logical partition are not wasted by shutting down the dead logical partition.

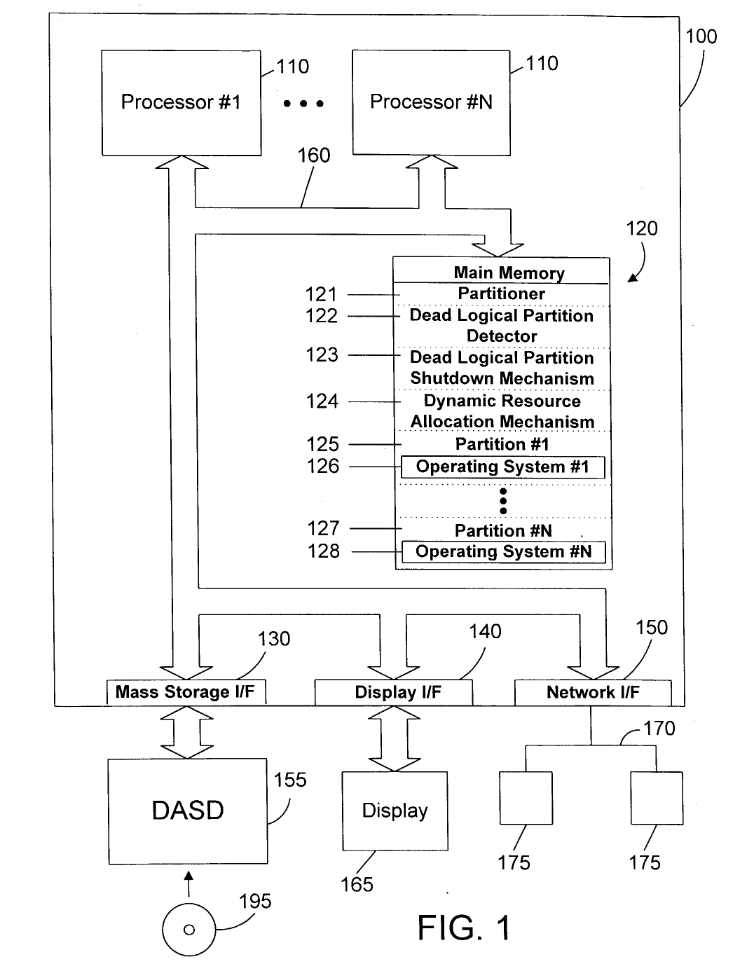

Referring to FIG. 1, a computer system 100 is an enhanced IBM iSeries computer system, and represents one suitable type of computer system that supports logical partitioning and dynamic resource allocation in accordance with the preferred embodiments. Those skilled in the art will appreciate that the mechanisms and apparatus of the present invention apply equally to any computer system that supports logical partitions. As shown in FIG. 1, computer system 100 comprises one or more processors 110 connected to a main memory 120, a mass storage interface 130, a display interface 140, and a network interface 150. These system components are interconnected through the use of a system bus 160. Mass storage interface 130 is used to connect mass storage devices (such as a direct access storage device 155) to computer system 100. One specific type of direct access storage device is a CD RW drive, which may read data from a CD RW 195.

Main memory 120 contains a partition manager 121, a dead logical partition detector 122, a dead logical partition shutdown mechanism 123, a dynamic resource allocation mechanism 124, and two logical partitions 125 and 127. Partition manager 121 preferably creates a primary partition 125 and one or more secondary partitions 127, both of which are logical partitions. The primary partition 125 preferably includes an operating system 126, and the secondary partition 127 also preferably includes an operating system 128.

Operating system 126 is a multitasking operating system known in the industry as OS/400; however, those skilled in the art will appreciate that the spirit and scope of the present invention is not limited to any one operating system. Any suitable operating system can be used. Operating system 126 is a sophisticated program that contains low-level code to manage the resources of computer system 100. Some of these resources are processor 110, main memory 120, mass storage interface 130, display interface 140, network interface 150, and system bus 160. The operating system 128 in each secondary partition 127 may be the same as the operating system 126 in the primary partition 125, or may be a completely different operating system. Thus, primary partition 125 can run the OS/400 operating system, while secondary partition 127 can run another instance of OS/400, possibly a different release, or with different environment settings (e.g., time zone). The operating system 128 in the secondary partition 127 could even be different than OS/400, provided it is compatible with the hardware. In this manner the logical partitions can provide completely different computing environments on the same physical computer system.

Dead logical partition detector 122 detects when one of the logical partitions 125 and 127 ceases to function properly. Once dead logical partition detector 122 detects a dead logical partition, it notifies the dynamic resource allocation mechanism 124 that the logical partition has died. While a single dead logical partition detector 122 is shown in FIG. 1, in the preferred embodiments each partition includes a dead logical partition detector that monitors the health of a different logical partition. Thus, for a system with two logical partitions in the preferred embodiments, each logical partition would have a dead logical partition detector to monitor the health of the other logical partition. One suitable example for dead logical partition detector 122 is a computer program known as Heartbeat, which is an open source high availability program that can be downloaded from www.linux-ha.org. Heartbeat broadcasts a signal at a specified time interval to show that the logical partition is still operating correctly. In the event that a first logical partition does not receive a signal from a second logical partition in the specified time interval, the first logical partition knows the second logical partition is dead.

Dead logical partition shutdown mechanism 123 is used to shut down a dead logical partition. One suitable example of dead logical partition shutdown mechanism 123 is a computer program known as STONITH, which stands for Shoot The Other Node In The Head. STONITH is another open source high availability program that can be downloaded from www.linux-ha.org. STONITH provides a hardware independent interface to implement hardware dependent shutdown procedures.

Dynamic resource allocation mechanism 124 is used to reallocate resources owned by a dead logical partition to a living logical partition after the dead logical partition is shut down. When the dead logical partition detector 122 notifies the dynamic resource allocation mechanism 124 that a logical partition has died, the dynamic resource allocation mechanism 124 attempts to allocate the shared resources of the dead logical partition to a live logical partition. In an iSeries computer system, the dynamic resource allocation mechanism 124 uses the Java Toolbox API to send a message in extensible markup language (XML) to the primary partition that reallocates shared resources from the dead logical partition to a live logical partition after shutting down the dead logical partition using the dead logical partition shutdown mechanism 123. In this manner, the dead logical partition's resources are not wasted when the dead logical partition is shut down, because the dead logical partition's resources are preferably reallocated to living logical partitions after shutting down the dead logical partition.

The partitions 125 and 127 are shown in FIG. 1 to reside within the main memory 120. However, one skilled in the art will recognize that a partition is a logical construct that includes resources other than memory. A logical partition typically specifies a portion of memory, along with an assignment of processor capacity and other system resources. Thus, primary partition 125 could be defined to include two processors and a portion of memory 120, along with one or more I/O processors that can provide the functions of mass storage interface 130, display interface 140, network interface 150, or interfaces to other I/O devices. The secondary partition 127 could then be defined to include three other processors, a different portion of memory 120, and one or more I/O processors. The partitions are shown in FIG. 1 to symbolically represent logical partitions, which would include system resources outside of memory 120 within computer system 100. Note also that the partitioner 121, the dead logical partition detector 122, the dead logical partition shutdown mechanism 123, and the dynamic resource allocation mechanism 124 preferably reside in the primary partition 125, but could reside in any of the defined partitions in the computer system 100, or even on a computer system 175 coupled to computer system 100 via network 170. Furthermore, while the dead logical partition detector 122, dead logical partition shutdown mechanism 123, and dynamic resource allocation mechanism 124 are shown separate in FIG. 1, the preferred embodiments expressly extend to a dynamic resource allocation mechanism 124 that includes the functions of the dead logical partition detector 122 and the dead logical partition shutdown mechanism 123.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while partition manager 121 and the partitions 125 and 127 are shown to reside in main memory 120, those skilled in the art will recognize that these items are not necessarily all completely contained in main memory 120 at the same time. It should also be noted that the term “memory” is used herein to generically refer to the entire virtual memory of computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up the partition manager 121, which initializes the operating systems in the logical partitions.

Although computer system 100 is shown to contain only a single system bus, those skilled in the art will appreciate that the present invention may be practiced using a computer system that has multiple buses. In addition, the interfaces (called input/output processors in AS/400 terminology) that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer readable signal bearing media used to actually carry out the distribution. Examples of suitable signal bearing media include: recordable type media such as floppy disks and CD RW (e.g., 195 of FIG. 1), and transmission type media such as digital and analog communications links.

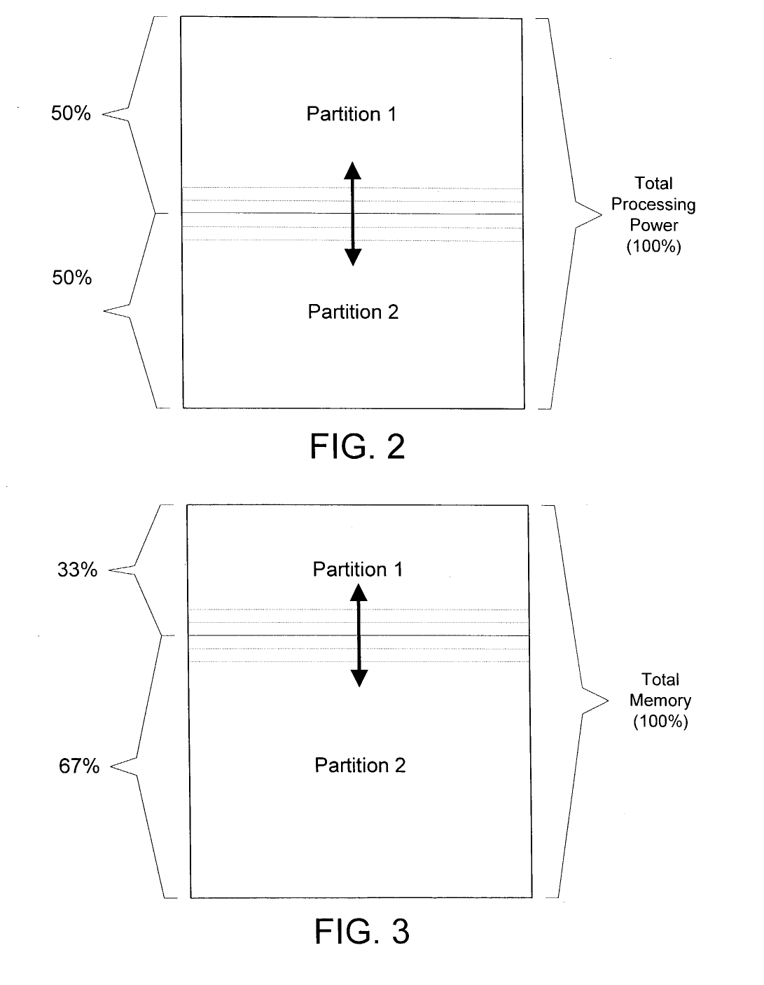

FIG. 2 shows how total processing power of a computer system may be allocated to logical partitions when they are created. We assume that partition manager 121 is used to specify that total processing power of a computer system is divided evenly, 50% allocated to a first logical partition (Partition 1) and 50% allocated to a second logical partition (Partition 2). FIG. 3 shows how the total memory of a computer system may be allocated to logical partitions when they are created. We assume that partition manager 121 is used to specify that total memory of a computer system is divided, with 33% allocated to Partition 1 and 67% allocated to Partition 2. Note that FIGS. 2 and 3 both include arrows at the dividing line between partitions that illustrate that the percentages could be changed from that shown in these figures. The specific values shown in FIGS. 2 and 3 are shown as examples for illustrating the principles of the present invention.

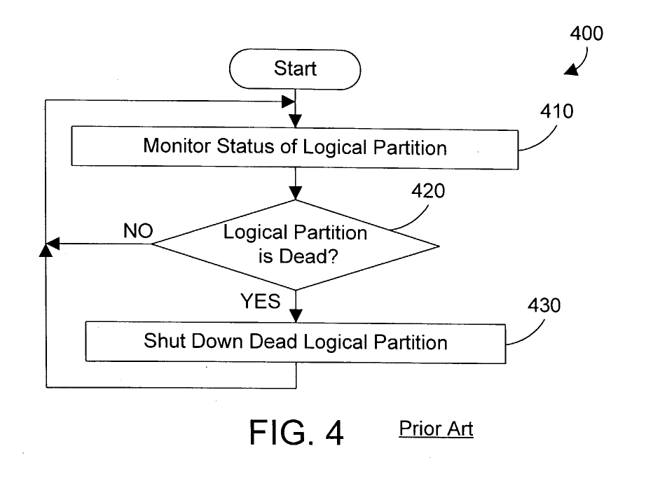

A prior art method 400 for handling dead logical partitions is shown in FIG. 4. The status of a logical partition is monitored (step 410). If the logical partition is not dead (step 420=NO), method 400 returns to the monitoring in step 410. If the logical partition is dead (step 420=YES), the dead logical partition is shut down (step 430).

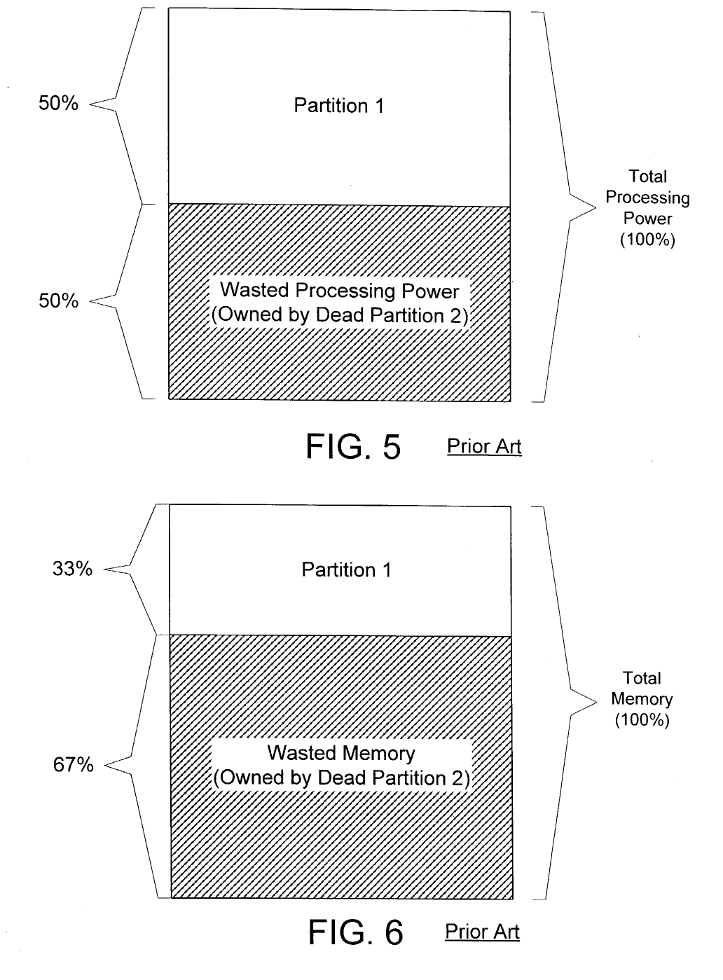

The problem with shutting down a dead logical partition is shown graphically in FIGS. 5 and 6. As shown in FIG. 5, when the dead logical partition is shut down in step 430 of FIG. 4, the processing power allocated to the dead logical partition is wasted, because the logical partition that owns 50% of the processing power has been shut down. Likewise in FIG. 6, when the dead logical partition is shut down, the memory allocated to the dead logical partition is wasted, because the logical partition that owns 67% of memory has been shut down.

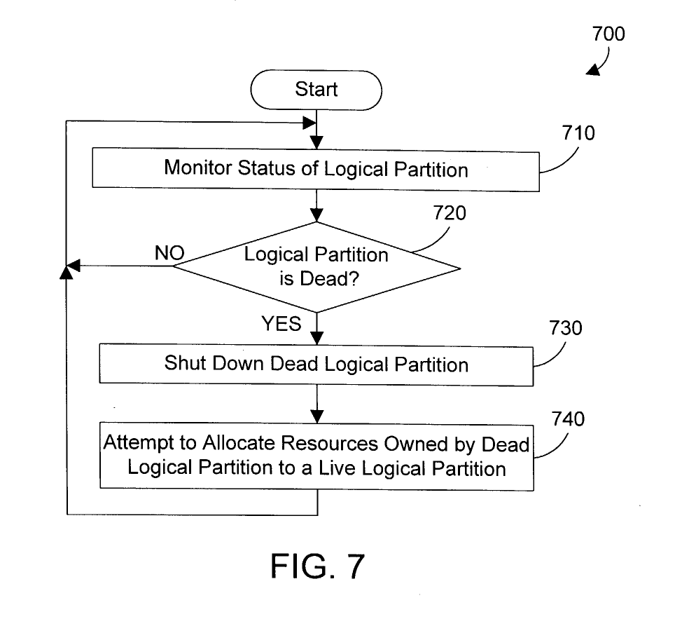

Referring to FIG. 7, a method 700 shows steps preferably performed by the dead logical partition detector 122 and dynamic resource allocation mechanism 124 in FIG. 1. Method 700 in accordance with the preferred embodiments monitors status of a logical partition (step 710). If the logical partition is not dead (step 720=NO), method 700 returns to step 710 for continued monitoring. If the logical partition is dead (step 720=YES), the dead logical partition is shut down (step 730). An attempt is then made to allocate the resources owned by the dead logical partition to a live logical partition (step 740).

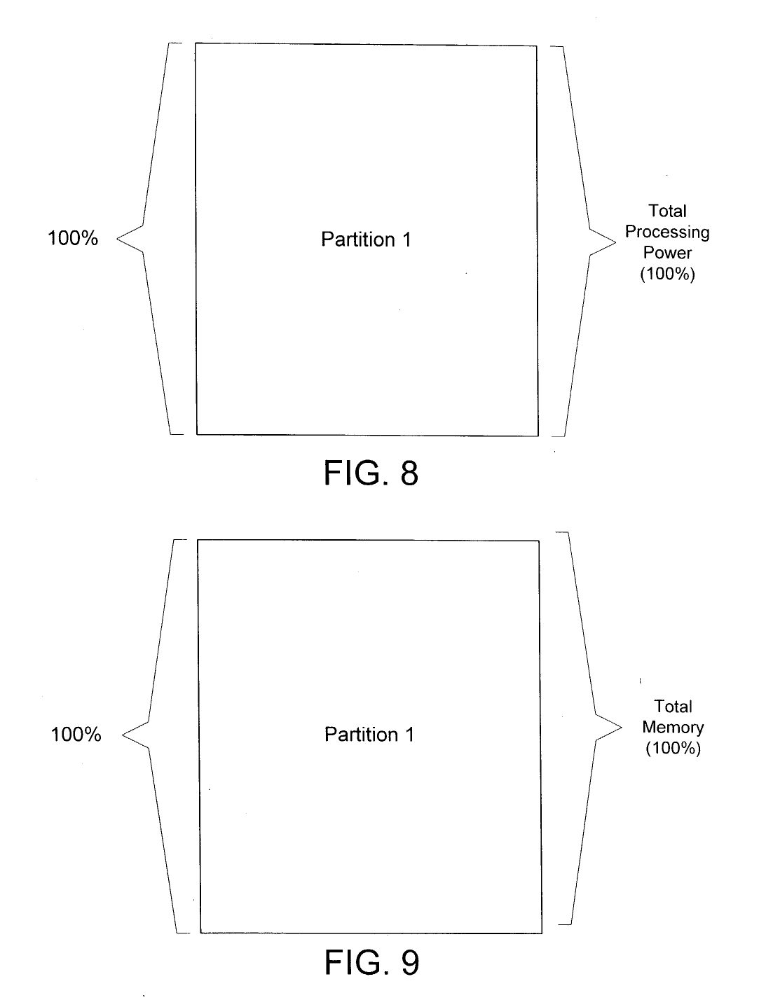

The effect of attempting to allocate resources owned by the dead logical partition to a live logical partition after shutting down the dead logical partition is illustrated graphically in FIGS. 8 and 9. We assume that the attempt to allocate the resources owned by Partition 2 to Partition 1 in step 730 was successful. The result is that Partition 1 now has its original percentage of processing power plus the percentage that Partition 2 used to have. For this two partition example, the result is that partition 1 has 100% of the total processing power, as shown in FIG. 8. In similar fashion, FIG. 9 shows that Partition 1 now has 100% of the total memory. FIGS. 8 and 9 graphically illustrate the difference between the present invention and the prior art shown in FIGS. 5 and 6. The present invention eliminates wasted resources that are owned by a dead logical partition by reallocating these resources, where possible, to a live logical partition after shutting down the dead logical partition.

Note that step 730 of FIG. 7 “attempts” to reallocate resources owned by the dead logical partition to a live logical partition. Whether or not this attempt is successful or not depends on the severity of the failure in the dead logical partition. In some cases, the dynamic resource allocation mechanism will be unable to reallocate one or more resources owned by a dead logical partition, but in the preferred embodiments it attempts to reallocate all resources owned by a dead logical partition to a live logical partition. The result is that every resource owned by the dead logical partition that can be reallocated to a live logical partition is reallocated, thus minimizing wasted resources that result from shutting down a dead logical partition.

The term “dead logical partition” has been used extensively herein. This term is used broadly to refer to any logical partition that ceases to function correctly. The type of the malfunction is not important. If the malfunction is severe enough to warrant shutting down the logical partition, the logical partition is considered a dead logical partition. The dead logical partition may still be running, or may be stalled due to some error or exception that prevents the logical partition from continuing program execution. The preferred embodiments prevent wasting resources that are owned by a dead logical partition by reallocating those resources to a live partition, where possible, after shutting down the dead logical partition.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor;
first and second logical partitions defined on the apparatus, wherein the first and second logical partitions each own predefined portions of a shared resource; and
a dynamic resource allocation mechanism residing in the memory and executed by the at least one processor, wherein the dynamic resource allocation mechanism attempts to allocate the predefined portion of the shared resource that is owned by the second logical partition to the first logical partition when the second logical partition ceases to function correctly.

2. The apparatus of claim 1 wherein the dynamic resource allocation mechanism executes a function that shuts down the second logical partition before attempting to allocate the predefined portion of the shared resource owned by the second logical partition to the first logical partition.

3. The apparatus of claim 1 wherein the shared resource comprises the memory.

4. The apparatus of claim 1 wherein the share resource comprises the at least one processor.

5. An apparatus comprising:
at least one processor;
a memory coupled to the at least one processor;
first and second logical partitions defined on the apparatus, wherein the first and second logical partitions each own predefined portions of a shared resource; and
a dynamic resource allocation mechanism residing in the memory and executed by the at least one processor, wherein the dynamic resource allocation mechanism performs the steps of:
1) if the second logical partition ceases to function correctly, shutting down the second logical partition; and
2) attempting to allocate the predefined portion of the shared resource that is owned by the second logical partition to the first logical partition.

6. The apparatus of claim 5 wherein the shared resource comprises the memory.

7. The apparatus of claim 5 wherein the share resource comprises the at least one processor.

8. A computer-implemented method for managing a shared resource in a computer system that includes first and second logical partitions that each own predefined portions of the shared resource, the method comprising the steps of:
(A) detecting when the second logical partition ceases to function correctly; and
(B) attempting to allocate the predefined portion of the shared resource that is owned by the second logical partition to the first logical partition.

9. The method of claim 8 further comprising the step of:
(C) shutting down the second logical partition.

10. The method of claim 8 wherein the shared resource comprises memory.

11. The method of claim 8 wherein the shared resource comprises at least one processor.

12. A program product comprising:
a dynamic resource allocation mechanism that attempts to allocate a predefined portion of a shared resource that is owned by a second logical partition to a first logical partition when the second logical partition ceases to function correctly; and
computer readable signal bearing media bearing the dynamic resource allocation mechanism.

13. The program product of claim 12 wherein the signal bearing media comprises recordable media.

14. The program product of claim 12 wherein the signal bearing media comprises transmission media.

15. The program product of claim 12 wherein the dynamic resource allocation mechanism executes a function that shuts down the second logical partition before attempting to allocate the predefined portion of the shared resource owned by the second logical partition to the first logical partition.

16. The program product of claim 12 wherein the shared resource comprises memory.

17. The program product of claim 12 wherein the share resource comprises at least one processor.

18. A program product comprising:
(A) a dynamic resource allocation mechanism that performs the steps of:
1) if a second logical partition ceases to function correctly, shutting down the second logical partition; and
2) attempting to allocate a predefined portion of a shared resource that is owned by the second logical partition to a first logical partition; and
(B) computer readable signal bearing media bearing the dynamic resource allocation mechanism.

19. The program product of claim 18 wherein the signal bearing media comprises recordable media.

20. The program product of claim 18 wherein the signal bearing media comprises transmission media.

21. The program product of claim 18 wherein the shared resource comprises memory.

22. The program product of claim 18 wherein the shared resource comprises at least one processor.
